(19) United States
(12) Patent Application Publication
(10) Pub. No.: US 2006/0139938 A1
(43) Pub. Date: Jun. 29, 2006

(54) Vehicle lighting apparatus

(76) Inventor: Toshihisa Hayami, Shizuoka (JP)

Correspondence Address: FISH & RICHARDSON P.C., P.O. BOX 1022, MINNEAPOLIS, MN, 55440-1022, US

(21) Appl. No.: 11/312,895

(22) Filed: Dec. 19, 2005

(30) Foreign Application Priority Data
Dec. 27, 2004 (JP) P. 2004-375664

(51) Int. Cl. B60Q 1/10

(52) U.S. Cl. 362/466

(57) ABSTRACT

A lighting apparatus is provided with a swivel device, a leveling device, a distribution light changeover device for switching the light distribution between a main-beam and a sub-beam, and a controller coupled to the devices via signal transmission paths. The controller controls the devices in accordance with a traveling condition of a vehicle. When an abnormality of the swivel device, the leveling device or the signal transmission paths is detected, the controller forcedly switches the light distribution to the sub-beam. The light distribution is also switched to the sub-beam when the swivel device or the leveling device stops at the dazzling position, thereby preventing the dazzling.

The present application claims foreign priority based on Japanese Patent Application No. P. 2004-375664, filed on Dec. 27, 2004, the contents of which are incorporated herein by reference.

### BACKGROUND OF THE INVENTION

1. Field of the Invention

The present invention relates to a vehicle lighting apparatus, in particular, relates to a vehicle lighting apparatus which includes an adaptive front-lighting system (hereafter referred to an AFS), for example, and secures traveling safety as to a faulty occurring on the system.

2. Related Art

JP-A-2002-326535 and JP-A-2002-326536 disclose an AFS for improving the traveling safety of automobiles. In the AFS, the steering angle and the vehicle speed etc. of an automobile are detected and an electronic control unit (hereinafter referred to an ECU) controls swivel headlamps. The swivel headlamps are headlamps in each of which a light beam irradiation direction can be controlled so as to be swung in the left and right directions, provided at the left and right portions of the front portion of the automobile. According to the AFS, when the automobile travels on a curved road, it is possible to irradiate a portion of the road ahead of the curve according the traveling speed of the automobile, which is effective in improving the traveling safety. Further, in JP-A-2002-326535 and JP-A-2002-326536, it is disclosed that, in order not to dazzle other vehicles and walkers etc. when an abnormality occurs in the AFS and so the control of the irradiation direction of the headlamps becomes difficult, the light distribution of the swivel lamp is fixed to the front direction or directed downward when the abnormality is detected.

In the AFS of JP-A-2002-326535 and JP-A-326536, the swing control is performed with reference to the optical axis of the headlamp. Thus, in a state where the sub-beam (also called as a passing-beam or a lower-beam) is lightened by the headlamp, other vehicles and walkers can be effectively prevented from being dazzled even in a case of the occurrence of an abnormality. However, in a state where the main-beam (also called as a driving-beam, an upper-beam or a high-beam) is lightened by the headlamp, since the main-beam includes a light distribution area directed upward than the horizontal direction of a vehicle, dazzling can not be prevented by only directing the light distribution to the front direction as disclosed in JP-A-2002-326535. Moreover, it is difficult to direct the light distribution of the main-beam downward than the horizontal direction even in the case of directing the light distribution downward as disclosed in JP-A-326536. Therefore, in the AFS of JP-A-326536, it is insufficient to prevent the dazzling completely.

### SUMMARY OF THE INVENTION

One or more embodiments of the present invention provide a vehicle lighting apparatus which can prevent other vehicles and walkers from being dazzled in a case where a failure occurs in an AFS.

In accordance with one or more embodiments of the present invention, a vehicle lighting apparatus is provided with a swivel device for changing an irradiation direction of a lamp in a horizontal direction; a leveling device for changing the irradiation direction in a vertical direction; a distribution light changeover device for switching a distribution of a light of the lamp between a main-beam and a sub-beam; and a controller coupled to the swivel device, the leveling device and the distribution light changeover device via signal transmission devices, and controls the swivel device, the leveling device and the distribution light changeover device in accordance with a traveling condition of the vehicle. In the vehicle lighting apparatus, the controller is capable of detecting an abnormality of each of the swivel device, the leveling device and the signal transmission devices, and when the abnormality of one of the devices is detected, the controller switches the distribution of the light to the sub-beam by actuating the distribution light changeover device.

Moreover, in accordance with one or more embodiments of the present invention, in the vehicle lighting apparatus, when the abnormality is detected, the controller may fix the irradiation direction of the lamp to a predetermined direction which does not cause dazzling, by using the swivel device in a normal state.

Moreover, in accordance with one or more embodiments of the present invention, in the vehicle lighting apparatus, when the abnormality is detected, the controller may fix the irradiation direction of the lamp to a predetermined direction which does not cause dazzling, by using the leveling device in a normal state.

Moreover, in accordance with one or more embodiments of the present invention, in the vehicle lighting apparatus, when the abnormality of the leveling device is detected, the irradiation direction is fixed to a predetermined left or right direction by the swivel device.

Moreover, in accordance with one or more embodiments of the present invention, in the vehicle lighting apparatus, when the abnormality of the swivel device is detected, the irradiation direction is swung to a predetermined downward direction by the leveling device.

Moreover, in accordance with one or more embodiments of the present invention, in the vehicle lighting apparatus, when the abnormality of only one of a right headlamp and a left headlamp is detected, the only abnormal headlamp is switched into the sub-beam.

In accordance with one or more embodiments of the present invention, a vehicle lighting apparatus is provided with a swivel device for changing an irradiation direction of a lamp in a horizontal direction; a leveling device for changing the irradiation direction in a vertical direction; a distribution light changeover device for switching a distribution of a light of the lamp between a main-beam and a sub-beam; a light quantity controller for controlling a quantity of the light of the lamp; and a controller coupled to the swivel device, the leveling device, the distribution light changeover device and the light quantity controller via signal transmission devices, and controls the swivel device, the leveling device, the distribution light changeover device and the light quantity controller in accordance with a traveling condition of the vehicle. In the vehicle lighting device, the controller is capable of detecting an abnormality of each of the swivel device, the leveling device, the distribution light changeover device and the signal transmission device, and when the abnormality of one of the devices is detected, the controller fades or extinguishes the light quantity of the lamp by using the light quantity controller.

Moreover, in accordance with one or more embodiments of the present invention, in the vehicle lighting apparatus, when the abnormality is detected, the controller may fix the irradiation direction of the lamp to a predetermined direction which does not cause dazzling, by using the swivel device in a normal state.

Moreover, in accordance with one or more embodiments of the present invention, in the vehicle lighting apparatus, when the abnormality is detected, the controller may fix the irradiation direction of the lamp to a predetermined direction which does not cause dazzling, by using the leveling device in a normal state.

Moreover, in accordance with one or more embodiments of the present invention, in the vehicle lighting apparatus, when the abnormality of the leveling device is detected, the irradiation direction is fixed to a predetermined left or right direction by the swivel device.

Moreover, in accordance with one or more embodiments of the present invention, in the vehicle lighting apparatus, when the abnormality of the swivel device is detected, the irradiation direction is swung to a predetermined downward direction by the leveling device.

Moreover, in accordance with one or more embodiments of the present invention, in the vehicle lighting apparatus, when the abnormality of only one of a right headlamp and a left headlamp is detected, the only abnormal headlamp is faded or extinguished.

The swivel device according to one or more embodiments of the present invention is configured by a swivel mechanism for swinging the irradiation direction of the lamp in the horizontal (left and right direction) and a swivel driving circuit for driving the swivel mechanism. The leveling device according to one or more embodiments of the present invention is configured by a leveling mechanism for swinging the irradiation direction of the lamp in the vertical (upper and lower direction) and a leveling driving circuit for driving the leveling mechanism. The distribution light changeover device according to one or more embodiments of the present invention is configured by a beam changeover mechanism for switching the light distribution characteristics between a main-beam such as a high-beam (upper beam, driving beam) and a sub-beam such as a lower-beam (passing beam) and a beam changeover circuit for driving the beam changeover mechanism. The beam changeover mechanism is configured by a shade for limiting the emitted light from the lamp, for example. The beam changeover circuit is a driving circuit for driving the shade. The light quantity controller according to one or more embodiments of the present invention is configured by a circuit for controlling a light quantity of the light source of the lamp and includes functions of reducing the light quantity and extinguishing.

According to one or more embodiments of the present invention, in the case where an abnormality occurs at the swivel device and the leveling device, if the irradiation light of the lamp is the main-beam, the distribution light changeover device switches the light beam into the sub-beam thereby to prevent the dazzling. In contrast, if the irradiation light of the lamp is the sub-beam, the irradiation direction of the lamp is subjected to the swivel control or the leveling control by the device in a normal state thereby to surely prevent the dazzling.

In contrast, in the case where an abnormality occurs at the swivel device, the leveling device and the distribution light changeover device, if the irradiation light of the lamp is the main-beam, the light quantity controller reduces the light quantity of the lamp or extinguishes the lamp thereby to surely prevent the dazzling. In contrast, if the irradiation light of the lamp is the sub-beam, the irradiation direction of the lamp is subjected to the swivel control or the leveling control by the device in a normal state thereby to surely prevent the dazzling.

Other aspects and advantages of the invention will be apparent from the following description and the appended claims.

### BRIEF DESCRIPTION OF THE DRAWINGS

FIG. 1 is a schematic diagram showing the configuration of the vehicle lighting apparatus according to the invention.

FIG. 2 is a block diagram showing a main portion of the vehicle lighting apparatus according to the invention.

FIG. 3 is a typical perspective view showing the schematic configuration of a headlamp.

FIG. 4 is a flowchart for explaining the action for preventing dazzling in the invention.

### DESCRIPTION OF THE PREFERRED EMBODIMENTS

Embodiments of the invention will be described with reference to the accompanying drawings.

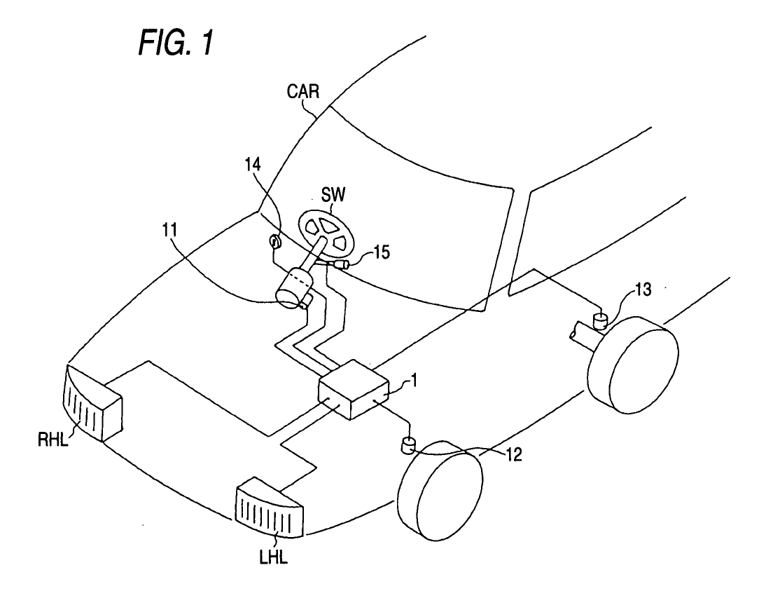

A first embodiment of the invention will be explained with reference to drawings. FIG. 1 is a schematic diagram showing the configuration of the embodiment in which the invention is applied to headlamps of an automobile. Each of the left and right headlamps LHL, RHL of an automobile CAR is configured in a manner that the irradiation direction thereof is controlled so as to be swung in a horizontal direction (a left and right direction) and a vertical direction (an upper and lower direction). In this respect, the control in the horizontal direction is the swivel control and the control in the vertical direction is the leveling control. The ECU 1 is configured as the controller for controlling the swing operation of the left and right headlamps LHL, RHL, for switching the light distribution characteristics of each of the headlamps between the main-beam and the sub-beam, and for controlling the brightness of each of the headlamps. In this respect, the main-beam includes the so-called high-beam (upper-beam) and the driving-beam in which the visibility at a distant place is improved at the time of traveling with a high speed. The sub-beam is the lower-beam or the passing-beam which does not dazzle oncoming vehicles. The ECU 1 is coupled to a steering sensor 11 for detecting the rotation angle of a steering wheel SW of an automobile or the steering angle of the automobile, a vehicle speed sensor 12 for detecting the vehicle speed of the automobile, and a vehicle height sensor 13 for detecting an inclined angle of the shaft line in the longitudinal direction of the automobile with respect to the horizontal direction. A steering angle signal, a vehicle speed signal and an inclined angle signal from the steering sensor, the vehicle speed sensor and the vehicle height sensor are supplied to the ECU 1. Since the configuration of each of the steering sensor 11, the vehicle speed sensor 12 and the vehicle height sensor 13 is known, the detailed explanation thereof will be omitted. Further, the ECU 1 is coupled to a main switch 14 for tuning the headlamps on and a beam changeover switch 15 for changing the light distribution between the main-beam and the sub-beam.

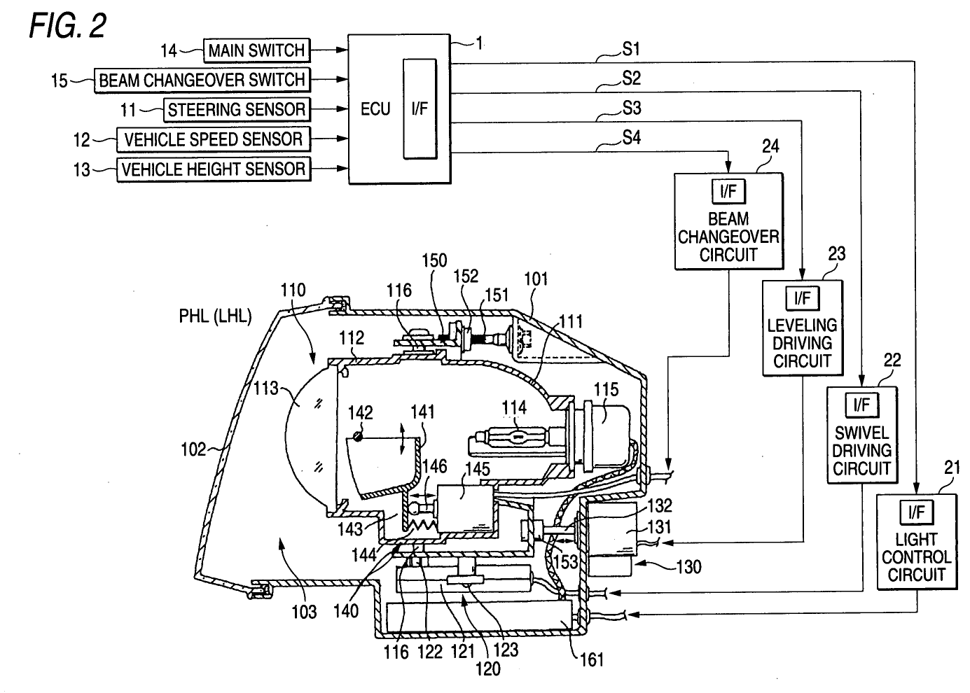

FIG. 2 is a block diagram of the configuration shown in FIG. 1. FIG. 2 shows only one of the left and right headlamps, that is, the right headlamp RHL in this case. The headlamp RHL includes a lamp body 101. The lamp body 101 is formed in a vessel shape which front face is opened and is attached with a cover 102 of a plain glass to the opening of the front face thereby to constitute a lamp chamber 103 within the lamp body. A lamp unit 110 of a projector type is disposed within the lamp chamber 103. The lamp unit 110 is configured so as to be controlled in a manner that the irradiation direction can be swung in the horizontal direction (the left and right direction) and the vertical direction (the upper and lower direction) by a swivel mechanism 120 (a swivel device 120) and a leveling mechanism 130 (a leveling device). Further, the lamp unit 110 is provided with a beam changeover mechanism 140 (a distribution light changeover device 140) for switching the light distribution between the main-beam and the sub-beam by driving a shade 141 provided within the lamp unit.

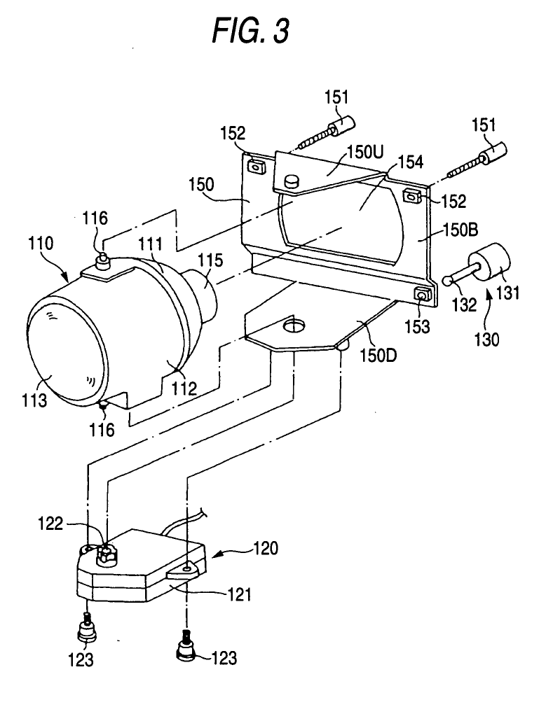

FIG. 3 is a partially exploded perspective view showing the inner structure of the headlamp RHL. Referring to FIGS. 2 and 3, in the lamp unit 110, a housing is formed by a reflector 111 of a spheroidal shape (a shape with an ellipsoid of revolution), a holder 112 coupled to the front edge portion of the reflector 111 and a lens 113 fixed to the front edge portion of the holder 112. A discharge bulb 114 serving as a light source is attached by means of a socket 115 which is attached to a bulb attachment hole provided at the rear face of the reflector 111.

The beam changeover mechanism 140, for limiting a light beam irradiated from the discharge bulb 114 thereby to switch from the main-beam to the sub-beam, is provided within the holder 112 of the lamp unit 110. The beam changeover mechanism 140 includes the shade 141 which is elevationally rotatable around a supporting shaft 142 so as to be able to move forward and backward on the optical axis in the forward direction of the discharge bulb 114, and a shade driving portion 143 for rotating the shade 141 in the vertical direction or the upper and lower direction. The shade driving portion 143 is configured by a spring 144 which biases and positions the shade 141 at a sub-beam position covering a part of the area in the forward direction of the discharge bulb 114, and a solenoid 145 having a plunger 146 which forcedly moves the shade 141 against the biasing force of the spring 144 to a main-beam position which evacuates the shade from the position on the optical axis in the forward direction of the discharge bulb 114. The solenoid 145 is coupled to a beam changeover circuit 24 which controls the supply of the current to the solenoid 145. According to the beam changeover mechanism 140, in the non-conductive state of the solenoid 145, the shade 141 is rotated and positioned by the biasing force of the spring 144 on the optical axis in the forward direction of the discharge bulb 114, thereby shielding a part of the light beam irradiated from the discharge bulb 114 to place the light distribution characteristics of the irradiation light from the lamp unit 110 in the sub-beam state. In contrast, when the solenoid 145 is supplied with a current by the beam changeover circuit 24, the shade 141 is rotated downward against the biasing force of the spring 144, thereby evacuating the shade from the position on the optical axis in the forward direction of the discharge bulb 114 to place the light distribution characteristics of the irradiation light from the lamp unit 110 in the main-beam state.

The lamp unit 110 is disposed within a frame 150 which is bent in an almost U-shape. The lamp unit is supported by rotary supporting shafts 116 respectively provided at the upper portion and the lower portion of the holder 112 so as to be rotatable in the horizontal direction around the rotary supporting shafts in a state of being sandwiched between the upper plate 150U and the lower plate 150D of the frame 150 and also in a state of being inserted into an opening 154 provided at the back plate 150B of the frame 150. The lamp unit 110 is rotatable in the horizontal direction by the swivel mechanism 120. The swivel mechanism 120 includes an actuator 121 serving as a rotational driving force. The actuator 121 is fixed to the lower surface of the lower plate 150D of the frame 150 by means of fixing screws 123. A rotary output shaft 122 protrudes from the upper surface of the actuator 121. The rotary output shaft 122 is coupled to the rotary supporting shaft 116 on the lower side of the lamp unit 110. The actuator 121 contains therein a not-shown motor and a transmission mechanism for changing the speed of the rotation output of the motor and so on, whereby the rotary output shaft 122 is rotated in accordance with the rotation of the motor. The actuator 121 is coupled to a swivel driving circuit 22. When the current conduction to the actuator 121 is controlled by the swivel driving circuit 22, the lamp unit 110 swings together with the rotary supporting shafts 116 within a required angular range by the rotation of the rotary output shaft 122, thereby inclining the optical axis of the lamp unit 110, that is, the irradiation direction in the left or right direction to perform the swivel control.

The frame 150 is supported by the lamp body 101 by means of aiming screws 151 engaging with aiming nuts 152 disposed at left and right portions of the upper edge of the back plate 150B, respectively. Further, the frame is coupled to the leveling mechanism 130 at a ball bearing 153 disposed at a portion of the lower edge of the frame. The leveling mechanism 130 includes a motor 131 having a coupling rod 132 which moves forward and backward along the longitudinal direction of the lamp unit 110. The motor 131 is fixed to the outer surface of the lamp body 101. The tip end portion of the coupling rod 132 is fit into the ball bearing 153 of the frame 150. The motor 131 is coupled to a leveling driving circuit 23 which controls the current conduction to the motor 131. In the leveling mechanism 130, when the motor 131 is driven by the leveling driving circuit 23, the coupling rod 132 is moved forward or backward along the axial direction thereof, whereby the frame 150 coupled to the coupling rod 132 swings in the vertical direction around the two aiming screws 151 at the upper edge serving as fulcrums. As a result, the optical axis of the lamp unit 110, that is, the irradiation direction inclined elevationally thereby to perform the leveling control. Incidentally, when the two aiming screws 151 are manually rotated so as to adjust their rotation, the two portions of the upper edge of the frame 150 are moved independently, whereby the inclination in the horizontal or left and right direction and the inclination in the vertical direction of the frame 150 are adjusted. Of course, this adjustment using the aiming screws 151 is performed in order to direct the optical axis of the lamp unit 110 to a predetermined elevational direction when an automobile assumes a predetermined posture.

The beam changeover circuit 24, the swivel driving circuit 22 and the leveling driving circuit 23 are coupled to the ECU 1 through signal transmission paths (signal transmission device) S4, S2 and S3, respectively. The ECU 1 sends required control signals to the beam changeover circuit 24, the swivel driving circuit 22 and the leveling driving circuit 23 through the signal transmission paths S4, S2 and S3, respectively, to control these circuits, thereby controlling the beam changeover mechanism 140, the swivel mechanism 120 and the leveling mechanism 130 to perform the beam switching control, the swivel control and the leveling control. The discharge bulb 114 of the lamp unit 110 is coupled through the connector 115 to a ballast (boosting) device 161 disposed at the inner bottom portion of the lamp body 101. The ballast device 161 is coupled to the ECU 1 and also coupled to a light control circuit 21 which is coupled to a not-shown power source (battery mounted on a vehicle). The ECU 1 controls the light control circuit 21 through the signal transmission path S1 thereby to adjust a light quantity of a light beam irradiated from the lamp unit 110. In this light control, it is possible, by controlling the ballast device 161, to reduce the light quantity of the discharge bulb 114 or to extinguish the discharge bulb 114. An interface I/F is provided at each of the ECU 1 and the respective circuits 21, 22, 23, 24 in order to transmit signals between the ECI 1 and the respective circuits 21, 22, 23, 24 via the signal transmission paths S1, S2, S3, S4. These interfaces constitute a signal transmission device of the invention.

The ECU 1 also includes an abnormality detection function. That is, the ECU 1 transmits predetermined signals at required timings to the respective circuits 22 to 24 via the signal transmission paths S2, S3, S4 which connect the ECU 1 with the swivel driving circuit 22, the leveling driving circuit 23, the beam changeover circuit 24, and monitors response signals sent from the respective circuits in response to the transmission signals. Thus the ECU can detect whether or not each of the respective circuits and each of the respective mechanisms 120, 130, 140 operate normally and also detect whether or not the signal transmission paths between the ECU 1 and the respective circuits 22 to 24 are normal. Then, when the ECU 1 detects the occurrence of an abnormality at one of the respective circuits, the mechanisms or the signal transmission paths, the ECU executes the failsafe control as described later to prevent oncoming vehicles and walkers from being dazzled.

The explanation will be made as to the control of the illumination, and in particular, the aforesaid failsafe control in the aforesaid configuration of the embodiment. When the main switch 14 is turned on, the ECU 1 controls the light control circuit 21 to turn on the discharge bulb 114 of the lamp unit 110. Further, when the beam changeover switch 15 is changed over to the main-beam side, the ECU 1 controls the beam changeover circuit 24 so as to drive the beam changeover mechanism 140 to move the shade 141 to the position evacuated from the position on the optical axis in the forward direction of the discharge bulb 114, thereby placing in the high-beam state. In contrast, when the beam changeover switch 15 is changed over to the sub-beam side, the shade 141 is moved to the position on the optical axis in the forward direction of the discharge bulb 114 thereby to shield a part of the light beam emitted from the discharge bulb 114, thereby placing in the sub-beam state.

When the steering operation is made during the traveling of the automobile CAR, the steering angle signal is inputted into the ECU 1 from the steering sensor 11. Simultaneously, the vehicle speed signal and the vehicle height signal of the automobile CAR are inputted into the ECU 1 from the vehicle speed sensor 12 and the vehicle height sensor 13, respectively. The ECU 1 calculates suitable irradiation directions of the headlamps RHL, LHL based on these inputted signals and controls the circuit 120 and the circuit 130 based on the calculation results. Thus, the swivel driving circuit 22 drives the swivel mechanism 120 so as to incline the lamp unit 110 in the left or right direction thereby to perform the swivel control in a manner that the irradiation direction of the lamp unit 110, that is, the irradiation direction of each of the headlamps RHL, LHL is set to the left or right direction suitably corresponding to the steering direction of the automobile CAR. Further, the leveling driving circuit 23 drives the leveling mechanism 130 so as to incline the frame 150 in the upper or lower direction thereby to perform the leveling control in a manner that the irradiation direction of the lamp unit 110, that is, the irradiation direction of each of the headlamps RHL, LHL is set to the upper or lower direction suitably corresponding to the steering direction of the automobile CAR.

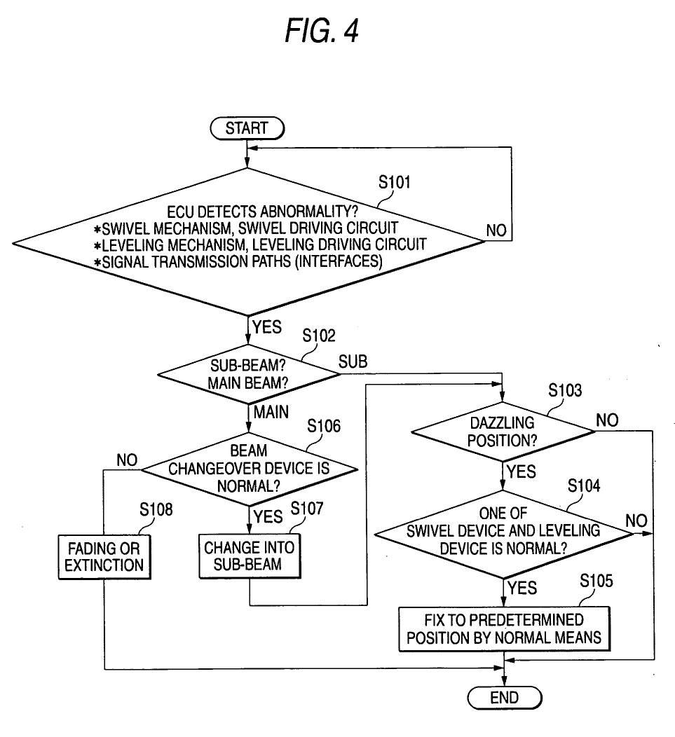

In such the AFS control of the headlamps RHL, LHL, when the ECU 1 detects an abnormality of the swivel mechanism 120 and the swivel driving circuit 22 for controlling the swivel mechanism, or an abnormality of the leveling mechanism 130 and the leveling driving circuit 23 for controlling the leveling mechanism, or an abnormality of the signal transmission paths S2, S3 coupling the ECU 1 and the respective circuits 22, 23, the swivel control and the leveling control of the lamp unit 110 by means of the ECU 1 can not be performed suitably. The explanation will be made as to the control in the case of the occurrence of such abnormalities with reference to a flowchart shown in FIG. 4. When the ECU 1 detects an abnormality of the respective mechanisms or the driving circuits or an abnormality of the respective signal transmission paths (S101), the determination is made whether the lamp unit 110 is changed over into the main-beam state or the sub-beam state (S102).

When it is determined that the lamp unit is changed into the sub-beam state, the current swing position of the lamp unit 110 is confirmed (S103). When the current swing position is directed to the irradiation direction which does not cause the dazzling, the current swing position is maintained. The irradiation direction which does not cause the dazzling is the left-side direction with reference to the straightly traveling direction of the automobile CAR in the case of the left-hand traffic, for example, and the lower direction than the horizontal direction of the automobile. (In the case of the right-hand traffic, such as United States, the irradiation direction which does not cause the dazzling is the right-side direction with reference to the straightly traveling direction of the automobile CAR and the lower direction than the horizontal direction of the automobile.) In step S103, when it is determined that the current swing position is directed to the irradiation direction which may cause the dazzling, then it is determined whether or not one of the swivel mechanism 120 and the leveling mechanism 130 is normal (S104). Then, the normal mechanism is driven to swingthe lamp unit 110 to the predetermined direction which does not cause the dazzling and then fixed thereto. This action to the predetermined direction is performed in a manner that, in the case where an abnormality occurs in the swivel mechanism 120 or the swivel driving circuit 22, the leveling driving circuit 23 is controlled so as to swing the irradiation direction to a predetermined downward direction by the leveling mechanism 130. In contrast, in the case where an abnormality occurs in the leveling mechanism 130 or the leveling driving circuit 23, the swivel driving circuit 22 is controlled so as to swing the irradiation direction to a predetermined left or right direction, that is, the left-side direction with reference to the straightly traveling direction of the automobile in the aforesaid example (the right-side direction with reference to the straightly traveling direction of the automobile in the right-hand traffic) by the swivel mechanism 120 and fix thereto. In this respect, the predetermined direction is a direction substantially same as the direction which does not cause the dazzling. When both the swivel mechanism 120 and the leveling mechanism 130 are abnormal, the swing position of the lamp unit 110 is maintained. However, since the light beam is the sub-beam, the influence of the dazzling on other vehicles and walkers can be suppressed to the minimum degree.

On the other hand, when the determination is made that the lamp unit 110 is in the main-beam state in step S102, a part of the irradiation light beam is irradiated in the upper direction than the horizontal direction or the right direction irrespective of the swing position of the lamp unit, so that other vehicles and walkers are dazzled. Thus, the ECU 1 determines whether or not an abnormality occurs in the beam changeover mechanism 140, the beam changeover circuit 24 or the signal transmission path S4 to the beam changeover circuit 24 (S106). When it is determined that there occurs no abnormality, the irradiation light is forcedly switched into the sub-beam in a manner that the beam changeover circuit 24 is controlled to drive the beam changeover mechanism 140 thereby to advance the shade 141 to the position on the optical axis in the forward direction of the discharge bulb 114 to shield a part of the irradiated light beam of the lamp unit 110 (S107). In this manner, oncoming vehicles and walkers are prevented from being dazzled.

Further, then the process again shifts to step S103, whereat the ECU 1 confirms the current swing position of the lamp unit 110 as described above. When the current swing position is directed to the irradiation direction which does not cause the dazzling, the current swing position is maintained. In contrast, when the current swing position is directed to the irradiation direction which may cause the dazzling, the normal mechanism is confirmed (S104) and then the lamp unit 110 is swung to the predetermined direction (S105). In this case, also, in the case where an abnormality occurs in the swivel mechanism 120 or the swivel driving circuit 22, the leveling mechanism 130 swings the irradiation direction to the predetermined downward direction. In contrast, in the case where an abnormality occurs in the leveling mechanism 130 or the leveling driving circuit 23, the swivel mechanism 120 swings the irradiation direction to the predetermined left or right direction, for example, the left-side direction with reference to the straightly traveling direction of the automobile and fix thereto. In this manner, in particular, oncoming vehicles and walkers are surely prevented from being dazzled.

Further in step S106, when the ECU 1 determines that an abnormality occurs in the beam changeover mechanism 140, the beam changeover circuit 24 or the signal transmission path S4 to the beam changeover circuit 24, the ECU 1 controls the light control circuit 21 thereby to fade or extinguish the discharge bulb 114 serving as the light source (S108). Thus, oncoming vehicles and walkers are prevented from being dazzled.

As described above, when the apparatus is placed in the condition that an abnormality occurs in one of the respective devices for swinging the headlamps RHL, LHL or one of the signal transmission paths between the ECU 1 and the headlamps RHL, LHL and so the dazzling can not be prevented when the ECU 1 only performs the swing control by suitably controlling the irradiation direction of the headlamps RHL, LHL, each of the headlamps RHL, LHL is switched in the sub-beam state by means of the beam changeover device formed by the beam changeover mechanism 140 and the beam changeover circuit 24, whereby it becomes possible to prevent the dazzling. Further, in the case where an abnormality occurs in the beam changeover mechanism 140, the beam changeover circuit 24 and the signal transmission path S4 to the beam changeover circuit 24 and so each of the headlamps RHL, LHL can not be switched into the sub-beam state, each of the headlamps RHL, LHL is faded or extinguished, whereby the dazzling can be surely prevented. Furthermore, in addition to the changeover, the fading or the extinction of the light beam, when the irradiation direction of the headlamps RHL, LHL is controlled so as to be swung in the predetermined left or right direction or the upper or lower direction by using the swing device in which no abnormality occurs, the dazzling can be prevented further surely.

Although the aforesaid explanation of the embodiment is based on the condition that the left and right headlamps RHL, LHL are controlled simultaneously, the invention may be arranged in the following manner. That is, when the ECU 1 performs the abnormality detection function thereby to detect an abnormality in one of the respective circuits, the respective mechanisms or the signal transmission paths to the respective circuits in one of the left and right headlamps, the normal AFS control may be performed as to the headlamp in the normal state, whilst the aforesaid dazzling preventing processing may be performed only as to the headlamp in which the abnormality occurs.

FIG. 2 is shown and the embodiment is explained in a manner that the swivel driving circuit 22, the leveling driving circuit 23 and the beam changeover circuit 24 are independently provided from the swivel mechanism 120, the leveling mechanism 130 and the beam changeover mechanism 140. However, these circuits can be integrally assembled by a circuit board etc. within the lamp body 101 of each of the headlamps RHL, LHL. Alternatively, each of these circuits can be integrally assembled with the corresponding one of the mechanisms as a part of the corresponding mechanism. The configurations of the swivel mechanism 120 and the leveling mechanism 130 are not limited to those of the embodiment and the invention can be applied to a configuration in which they can so long as swing the irradiation of the headlamp in the left and right direction and the upper and lower direction, respectively.

The headlamp according to the invention is not limited to the one having the projector type lamp unit described in the embodiment, and a reflector type lamp for reflecting a light beam emitted from the light source may be employed in the similar manner. In this case, also, the means for switching the beam between the main-beam and the sub-beam is not limited to the configuration like the embodiment in which the shade is driven to switch the beam. That is, the invention may be applied to such a lamp which is configured to change over between plural filaments of the bulb and to lighten the changed one.

The signal transmission device of the invention is not limited to the signal paths coupling the ECU and the respective circuits and, of course, includes so-called interfaces provided at the ECU and the respective circuits which are coupled to the corresponding signal paths and transmit and receive signals between the ECU and the respective circuits, respectively, as described above. Of course, the invention can be applied even when an abnormality occurs in one of these interfaces.

It will be apparent to those skilled in the art that various modifications and variations can be made to the described preferred embodiments of the present invention without departing from the spirit or scope of the invention. Thus, it is intended that the present invention cover all modifications and variations of this invention consistent with the scope of the appended claims and their equivalents.

What is claimed is:

1. A vehicle lighting apparatus comprising:
a swivel device for changing an irradiation direction of a lamp in a horizontal direction;
a leveling device for changing the irradiation direction in a vertical direction;
a distribution light changeover device for switching a distribution of a light of the lamp between a main-beam and a sub-beam; and
a controller coupled to the swivel device, the leveling device and the distribution light changeover device via signal transmission devices, and controls the swivel device, the leveling device and the distribution light changeover device in accordance with a traveling condition of the vehicle,
wherein the controller is capable of detecting an abnormality of each of the swivel device, the leveling device and the signal transmission devices, and
when the abnormality of one of the devices is detected, the controller switches the distribution of the light to the sub-beam by actuating the distribution light changeover device.

2. The vehicle lighting apparatus according to claim 1, when the abnormality is detected, the controller fixes the irradiation direction of the lamp to a predetermined direction which does not cause dazzling, by using the swivel device in a normal state.

3. The vehicle lighting apparatus according to claim 2, when the abnormality of the leveling device is detected, the irradiation direction is fixed to a predetermined left or right direction by the swivel device.

4. The vehicle lighting apparatus according to claim 1, when the abnormality is detected, the controller fixes the irradiation direction of the lamp to a predetermined direction which does not cause dazzling, by using the leveling device in a normal state.

5. The vehicle lighting apparatus according to claim 4, when the abnormality of the swivel device is detected, the irradiation direction is swung to a predetermined downward direction by the leveling device.

6. The vehicle lighting apparatus according to claim 1, when the abnormality of only one of a right headlamp and a left headlamp is detected, the only abnormal headlamp is switched into the sub-beam.

7. A vehicle lighting apparatus comprising:
a swivel device for changing an irradiation direction of a lamp in a horizontal direction;
a leveling device for changing the irradiation direction in a vertical direction;
a distribution light changeover device for switching a distribution of a light of the lamp between a main-beam and a sub-beam;
a light quantity controller for controlling a quantity of the light of the lamp; and
a controller coupled to the swivel device, the leveling device, the distribution light changeover device and the light quantity controller via signal transmission devices, and controls the swivel device, the leveling device, the distribution light changeover device and the light quantity controller in accordance with a traveling condition of the vehicle,
the controller is capable of detecting an abnormality of each of the swivel device, the leveling device, the distribution light changeover device and the signal transmission device, and
when the abnormality of one of the devices is detected, the controller fades or extinguishes the light quantity of the lamp by using the light quantity controller.

8. The vehicle lighting apparatus according to claim 7, when the abnormality is detected, the controller fixes the irradiation direction of the lamp to a predetermined direction which does not cause dazzling, by using the swivel device in a normal state.

9. The vehicle lighting apparatus according to claim 8, when the abnormality of the leveling device is detected, the irradiation direction is fixed to a predetermined left or right direction by the swivel device.

10. The vehicle lighting apparatus according to claim 7, when the abnormality is detected, the controller fixes the irradiation direction of the lamp to a predetermined direction which does not cause dazzling, by using the leveling device in a normal state.

11. The vehicle lighting apparatus according to claim 10, when the abnormality of the swivel device is detected, the irradiation direction is swung to a predetermined downward direction by the leveling device.

12. The vehicle lighting apparatus according to claim 7, when the abnormality of only one of a right headlamp and a left headlamp is detected, the only abnormal headlamp is faded or extinguished.
